(19) United States
(12) Patent Application Publication
(10) Pub. No.: US 2012/0044595 A1
(43) Pub. Date: Feb. 23, 2012

(54) PERPENDICULAR MAGNETIC RECORDING MEDIUM (PMRM) AND MAGNETIC STORAGE SYSTEMS USING THE SAME

(75) Inventors: Yotsuo Yahisa, Odawara (JP); Ichiro Tamai, Odawara (JP); Akemi Hirotsune, Odawara (JP)

(73) Assignee: Hitachi Global Storage Technologies Netherlands B.V., Amsterdam (NL)

(21) Appl. No.: 12/861,725

(22) Filed: Aug. 23, 2010

(51) Int. Cl. G11B 21/02; G11B 5/66

(52) U.S. Cl. 360/75; 428/827; 428/829; 427/131; G9B/21.003; G9B/5.241

(57) ABSTRACT

In one embodiment, a perpendicular magnetic recording medium (PMRM) includes a first interlayer comprising Ru or a Ru alloy, a second interlayer above the first interlayer comprising Ru or a Ru alloy, and a third interlayer formed between the first interlayer and the second interlayer that reduces an average cluster size of the second interlayer. In another embodiment, a PMRM includes a first interlayer comprising Ru or a Ru alloy, a second interlayer above the first interlayer comprising Ru or a Ru alloy, and a third interlayer formed between the first interlayer and the second interlayer that reduces an average cluster size of the second interlayer. The third interlayer has a thickness of between about 1.0 nm and about 3.0 nm and has a structure selected from a group consisting of: BCC, B2, C11b, L21, and D03. Other PMRMs and methods of fabrication are presented as well.

### FIELD OF THE INVENTION

The present invention relates to data storage systems, and more particularly, this invention relates to a perpendicular magnetic recording medium (PMRM), and magnetic storage apparatuses using PMRM.

### BACKGROUND OF THE INVENTION

The heart of a computer is a magnetic disk drive which typically includes a rotating disk, a slider that has read and write heads, a suspension arm above the rotating disk and an actuator arm that swings the suspension arm to place the read and/or write heads over selected circular tracks on the rotating disk. When the slider rides on the air bearing, the write and read heads are employed for writing magnetic impressions to, and reading magnetic signal fields from, the rotating disk. The read and write heads are connected to processing circuitry that operates according to a computer program to implement the writing and reading functions.

In typical systems, the disk is made of a magnetic recording medium composed of crystal grains, which form into groups called clusters. Storage capacity is determined by the composition of the magnetic recording medium, which should robustly tolerate heat and interference from external magnetic fields, while minimizing medium noise, such that it provides a good medium with which to write data to. Current approaches for optimizing performance generally involve reducing the size of crystal grains within the magnetic medium. Conventional methods for reducing crystal grain size produce smaller crystal grains, but these smaller crystal grains also exhibit deteriorated crystal orientation and reduced magnetic isolation. This in turn leads to increased interaction between the smaller crystal grains, which results in an increase in the overall cluster size distribution (e.g., the average cluster size increases, even with smaller crystal grains) and limits improvements to the recording and reproducing characteristics of the medium. Therefore, a method and/or system of overcoming the current limitations of reducing cluster size which can be used in recording and reproducing data with magnetic media would be very beneficial.

### SUMMARY OF THE INVENTION

In one embodiment, a perpendicular magnetic recording medium includes a first interlayer comprising Ru or a Ru alloy, a second interlayer above the first interlayer comprising Ru or a Ru alloy, and a third interlayer formed between the first interlayer and the second interlayer that reduces an average cluster size of the second interlayer.

In another embodiment, a perpendicular magnetic recording medium includes a first interlayer comprising Ru or a Ru alloy, a second interlayer above the first interlayer comprising Ru or a Ru alloy, and a third interlayer formed between the first interlayer and the second interlayer that reduces an average cluster size of the second interlayer. The third interlayer has a thickness of between about 1.0 nm and about 3.0 nm and has a structure selected from a group consisting of: BCC, B2, C11b, L21, and D03.

In yet another embodiment, a method for forming a perpendicular magnetic recording medium includes forming a multilayer interlayer, comprising forming a first interlayer above a substrate, forming a second interlayer above the first interlayer, and forming a third interlayer between the first interlayer and the second interlayer, and forming a perpendicular magnetic recording layer above the multilayer interlayer.

Any of these embodiments may be implemented in a magnetic data storage system such as a disk drive system, which may include a magnetic head, a drive mechanism for passing a magnetic medium (e.g., hard disk) over the magnetic head, and a controller electrically coupled to the magnetic head.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a simplified drawing of a magnetic recording disk drive system.

FIG. 2A is a schematic representation in section of a recording medium utilizing a longitudinal recording format.

FIG. 2B is a schematic representation of a conventional magnetic recording head and recording medium combination for longitudinal recording as in FIG. 2A.

FIG. 2C is a magnetic recording medium utilizing a perpendicular recording format.

FIG. 2D is a schematic representation of a recording head and recording medium combination for perpendicular recording on one side.

FIG. 2E is a schematic representation of a recording apparatus adapted for recording separately on both sides of the medium.

FIG. 3A is a cross-sectional view of one particular embodiment of a perpendicular magnetic head with helical coils.

FIG. 3B is a cross-sectional view of one particular embodiment of a piggyback magnetic head with helical coils.

FIG. 4A is a cross-sectional view of one particular embodiment of a perpendicular magnetic head with looped coils.

FIG. 4B is a cross-sectional view of one particular embodiment of a piggyback magnetic head with looped coils.

FIG. 5 is a cross-sectional view of one particular embodiment of a perpendicular magnetic recording medium (PMRM) utilizing a third interspersed layer of magnetic crystal grains.

FIG. 6A is a simplified drawing of one particular embodiment of seven adjacent in-phase crystal grains forming a magnetic cluster.

FIG. 6B is a simplified drawing of one particular embodiment of seven adjacent crystal grains, where three of the adjacent crystal grains are in-phase and form a magnetic cluster.

FIG. 6C is a simplified drawing of one particular embodiment of seven adjacent crystal grains, where two of the adjacent crystal grains are in-phase and form a magnetic cluster.

FIG. 7 is a plot showing one effect of smaller cluster size of the third interlayer, according to one embodiment.

FIG. 8 is a table showing comparisons between two exemplary embodiments and a comparative example.

FIG. 9 is a cross-sectional view of a perpendicular magnetic recording medium (PMRM) utilizing two or three interlayers, according to one embodiment and a comparative example.

FIG. 10 is a flowchart of a method for forming a perpendicular magnetic recording medium (PMRM), according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of disk-based storage systems and/or related systems and methods, as well as operation and/or component parts thereof.

In one general embodiment, a perpendicular magnetic recording medium includes a first interlayer comprising Ru or a Ru alloy, a second interlayer above the first interlayer comprising Ru or a Ru alloy, and a third interlayer formed between the first interlayer and the second interlayer that reduces an average cluster size of the second interlayer.

In another general embodiment, a perpendicular magnetic recording medium includes a first interlayer comprising Ru or a Ru alloy, a second interlayer above the first interlayer comprising Ru or a Ru alloy, and a third interlayer formed between the first interlayer and the second interlayer that reduces an average cluster size of the second interlayer. The third interlayer has a thickness of between about 1.0 nm and about 3.0 nm and has a structure selected from a group consisting of: BCC, B2, C11b, L21, and D03.

In yet another general embodiment, a method for forming a perpendicular magnetic recording medium includes forming a multilayer interlayer, comprising forming a first interlayer above a substrate, forming a second interlayer above the first interlayer, and forming a third interlayer between the first interlayer and the second interlayer, and forming a perpendicular magnetic recording layer above the multilayer interlayer.

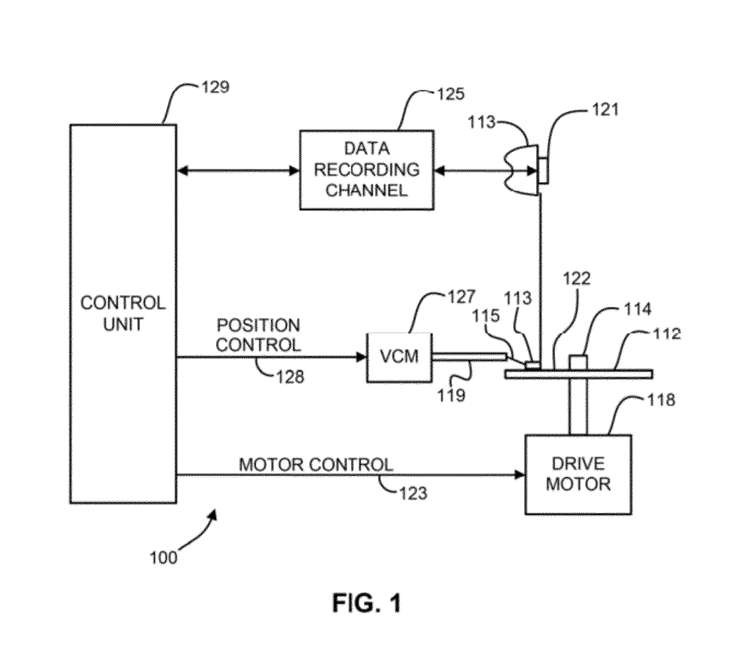

Referring now to FIG. 1, there is shown a disk drive 100 in accordance with one embodiment of the present invention. As shown in FIG. 1, at least one rotatable magnetic disk 112 is supported on a spindle 114 and rotated by a disk drive motor 118. The magnetic recording on each disk is typically in the form of an annular pattern of concentric data tracks (not shown) on the disk 112.

At least one slider 113 is positioned near the disk 112, each slider 113 supporting one or more magnetic read/write heads 121. As the disk rotates, slider 113 is moved radially in and out over disk surface 122 so that heads 121 may access different tracks of the disk where desired data are recorded and/or to be written. Each slider 113 is attached to an actuator arm 119 by means of a suspension 115. The suspension 115 provides a slight spring force which biases slider 113 against the disk surface 122. Each actuator arm 119 is attached to an actuator 127. The actuator 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of disk 112 generates an air bearing between slider 113 and disk surface 122 which exerts an upward force or lift on the slider 113. The air bearing thus counter-balances the slight spring force of suspension 115 and supports slider 113 off and slightly above the disk surface by a small, substantially constant spacing during normal operation. Note that in some embodiments, the slider 113 may slide along the disk surface 122.

The various components of the disk storage system are controlled in operation by control signals generated by control unit 129, such as access control signals and internal clock signals. Typically, control unit 129 comprises logic control circuits, storage (e.g., memory), and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Read and write signals are communicated to and from read/write heads 121 by way of recording channel 125.

The above description of a typical magnetic disk storage system, and the accompanying illustration of FIG. 1 is for representation purposes only. It should be apparent that disk storage systems may contain a large number of disks and actuators, and each actuator may support a number of sliders.

An interface may also be provided for communication between the disk drive and a host (integral or external) to send and receive the data and for controlling the operation of the disk drive and communicating the status of the disk drive to the host, all as will be understood by those of skill in the art.

In a typical head, an inductive write head includes a coil layer embedded in one or more insulation layers (insulation stack), the insulation stack being located between first and second pole piece layers. A gap is formed between the first and second pole piece layers by a gap layer at an air bearing surface (ABS) of the write head. The pole piece layers may be connected at a back gap. Currents are conducted through the coil layer, which produce magnetic fields in the pole pieces. The magnetic fields fringe across the gap at the ABS for the purpose of writing bits of magnetic field information in tracks on moving media, such as in circular tracks on a rotating magnetic disk.

The second pole piece layer has a pole tip portion which extends from the ABS to a flare point and a yoke portion which extends from the flare point to the back gap. The flare point is where the second pole piece begins to widen (flare) to form the yoke. The placement of the flare point directly affects the magnitude of the magnetic field produced to write information on the recording medium.

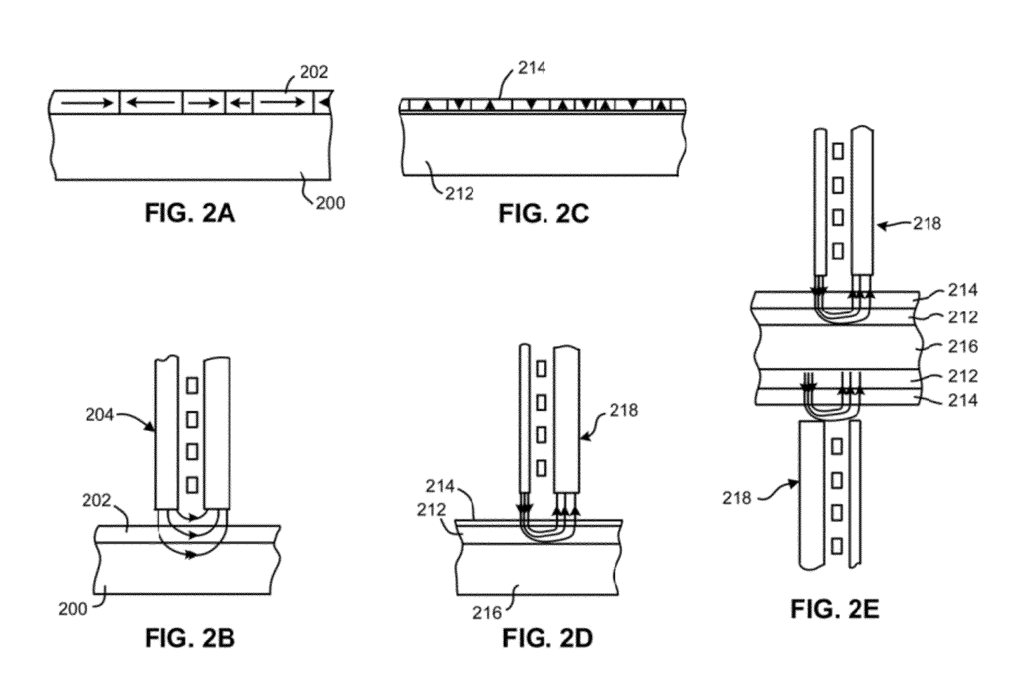

FIG. 2A illustrates, schematically, a conventional recording medium such as used with magnetic disc recording systems, such as that shown in FIG. 1. This medium is utilized for recording magnetic impulses in or parallel to the plane of the medium itself. The recording medium, a recording disc in this instance, comprises basically a supporting substrate 200 of a suitable non-magnetic material such as glass, with an overlying coating 202 of a suitable and conventional magnetic layer.

FIG. 2B shows the operative relationship between a conventional recording/playback head 204, which may preferably be a thin film head, and a conventional recording medium, such as that of FIG. 2A.

FIG. 2C illustrates, schematically, the orientation of magnetic impulses substantially perpendicular to the surface of a recording medium as used with magnetic disc recording systems, such as that shown in FIG. 1. For such perpendicular recording the medium typically includes an under layer 212 of a material having a high magnetic permeability. This under layer 212 is then provided with an overlying coating 214 of magnetic material preferably having a high coercivity relative to the under layer 212.

FIG. 2D illustrates the operative relationship between a perpendicular head 218 and a recording medium. The recording medium illustrated in FIG. 2D includes both the high permeability under layer 212 and the overlying coating 214 of magnetic material described with respect to FIG. 2C above. However, both of these layers 212 and 214 are shown applied to a suitable substrate 216. Typically there is also an additional layer (not shown) called an “exchange-break” layer or “interlayer” between layers 212 and 214.

In this structure, the magnetic lines of flux extending between the poles of the perpendicular head 218 loop into and out of the overlying coating 214 of the recording medium with the high permeability under layer 212 of the recording medium causing the lines of flux to pass through the overlying coating 214 in a direction generally perpendicular to the surface of the medium to record information in the overlying coating 214 of magnetic material preferably having a high coercivity relative to the under layer 212 in the form of magnetic impulses having their axes of magnetization substantially perpendicular to the surface of the medium. The flux is channeled by the soft underlying coating 212 back to the return layer (P1) of the head 218.

FIG. 2E illustrates a similar structure in which the substrate 216 carries the layers 212 and 214 on each of its two opposed sides, with suitable recording heads 218 positioned adjacent the outer surface of the magnetic coating 214 on each side of the medium, allowing for recording on each side of the medium.

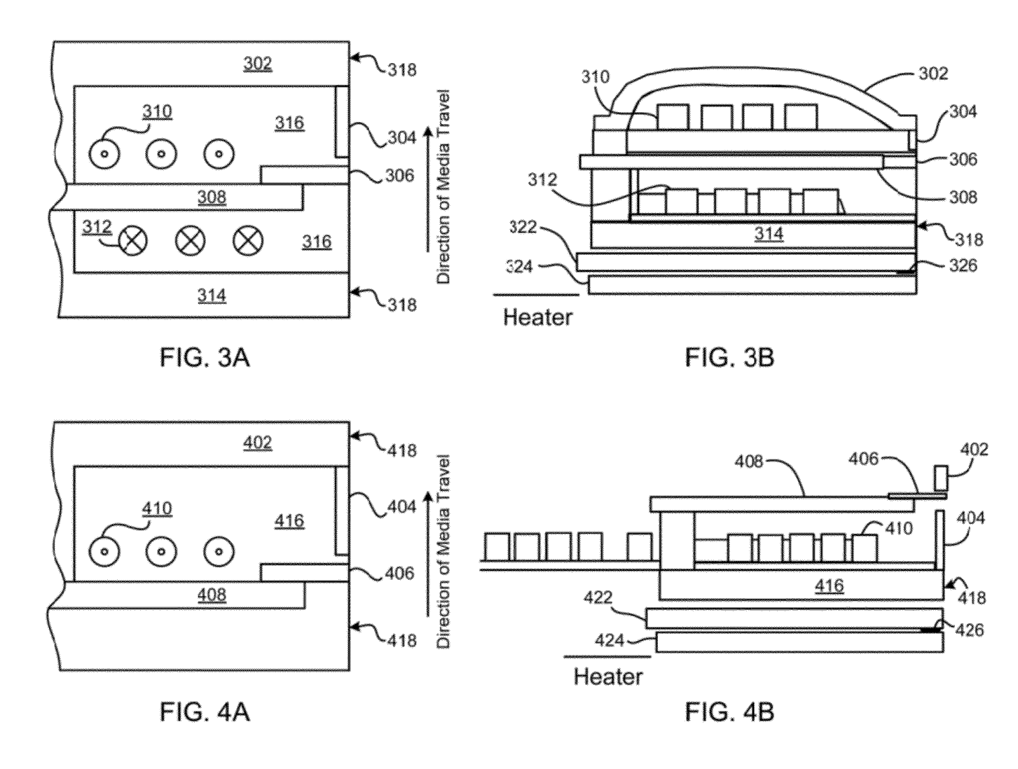

FIG. 3A is a cross-sectional view of a perpendicular magnetic head. In FIG. 3A, helical coils 310 and 312 are used to create magnetic flux in the stitch pole 308, which then delivers that flux to the main pole 306. Coils 310 indicate coils extending out from the page, while coils 312 indicate coils extending into the page. Stitch pole 308 may be recessed from the ABS 318. Insulation 316 surrounds the coils and may provide support for some of the elements. The direction of the media travel, as indicated by the arrow to the right of the structure, moves the media past the lower return pole 314 first, then past the stitch pole 308, main pole 306, trailing shield 304 which may be connected to the wrap around shield (not shown), and finally past the upper return pole 302. Each of these components may have a portion in contact with the ABS 318. The ABS 318 is indicated across the right side of the structure.

Perpendicular writing is achieved by forcing flux through the stitch pole 308 into the main pole 306 and then to the surface of the disk positioned towards the ABS 318.

FIG. 3B illustrates a piggyback magnetic head having similar features to the head of FIG. 3A. Two shields 304, 314 flank the stitch pole 308 and main pole 306. Also sensor shields 322, 324 are shown. The sensor 326 is typically positioned between the sensor shields 322, 324.

FIG. 4A is a schematic diagram of one embodiment which uses looped coils 410, sometimes referred to as a pancake configuration, to provide flux to the stitch pole 408. The stitch pole then provides this flux to the main pole 406. In this orientation, the lower return pole is optional. Insulation 416 surrounds the coils 410, and may provide support for the stitch pole 408 and main pole 406. The stitch pole may be recessed from the ABS 418. The direction of the media travel, as indicated by the arrow to the right of the structure, moves the media past the stitch pole 408, main pole 406, trailing shield 404 which may be connected to the wrap around shield (not shown), and finally past the upper return pole 402 (all of which may or may not have a portion in contact with the ABS 418). The ABS 418 is indicated across the right side of the structure. The trailing shield 404 may be in contact with the main pole 406 in some embodiments.

FIG. 4B illustrates another type of piggyback magnetic head having similar features to the head of FIG. 4A including a looped coil 410, which wraps around to form a pancake coil. Also, sensor shields 422, 424 are shown. The sensor 426 is typically positioned between the sensor shields 422, 424.

In FIGS. 3B and 4B, an optional heater is shown near the non-ABS side of the magnetic head, e.g., to induce thermal protrusion, thereby reducing flying height of the head relative to the disk. A heater (Heater) may also be included in the magnetic heads shown in FIGS. 3A and 4A. The position of this heater may vary based on design parameters such as where the protrusion is desired, coefficients of thermal expansion of the surrounding layers, etc.

In conventional magnetic medium, cluster sizes which comprise the magnetic medium affect the performance of the magnetic medium. The larger the magnetic clusters, the less amount of data may be stored to the magnetic medium. Put another way, by reducing the cluster size increased recording density may be achieved, according to preferred embodiments. This reduced cluster size may be achieved in several ways, according to various embodiments. In a first embodiment, the physical size of crystal grains may be reduced. In another embodiment, magnetic decoupling between neighboring crystal grains may be enhanced. According to another embodiment, size distribution may be narrowed, while avoiding degradation of the magnetic medium. In yet another embodiment, crystallographic texture may be improved while suppressing degradation of the magnetic medium to as great an extent as possible.

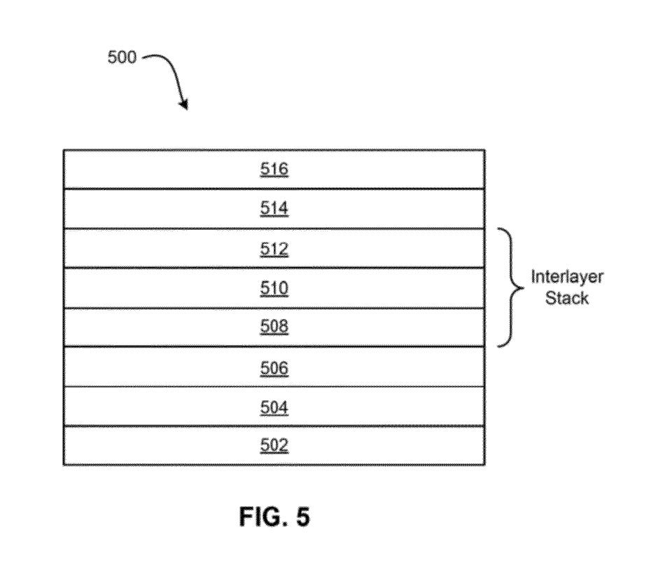

FIG. 5 illustrates a cross-sectional view depicting each layer of a perpendicular magnetic recording medium (PMRM) 500 according to one embodiment. A substrate layer 502 provides a foundation for subsequent layers, and may be comprised of any material known to one of skill in the art, such as glass, silicon, etc. Above the substrate layer 502, a soft magnetic layer 504 is positioned to return magnetic flux from a magnetic head. Above the soft magnetic layer 504, a crystalline seed layer 506 is positioned. The crystalline seed layer 506 has good crystallographic texture, which provides adequate crystal grain size for subsequent layers. This crystalline seed layer 506 is positioned below a series of interlayers comprised of a single metal, a metal alloy, combinations of metals, etc. The first interlayer 508 and second interlayer 512 may comprise Ru, a Ru alloy, etc., according to some embodiments. Positioned between the first and second interlayers 508, 512 is a third interlayer 510 having a body-centered cubic crystal (BCC) structure, B2 structure, C11b structure, L21 structure, D03 structure, etc.

When the third interlayer 510 utilizes a BCC structure, it may comprise Cr, V, etc., and preferably may have a thickness of between about 1.0 nm and about 3.0 nm. When the third interlayer 510 has any other structure, such as a B2, C11b, L21, D03, etc., structure, it preferably may be comprised of an intermetallic material or compound. For example, the intermetallic compound may include at least two elements selected from Al, Si, Ti, Cr, Mn, Fe, Co, Ni, Cu, Zr, Nb, Mo, Ru, Ta, and Re. Layered immediately above the second interlayer 512 is a perpendicular magnetic recording layer 514, in some approaches. The perpendicular magnetic recording layer 514 has good crystallographic texture, according to one embodiment, due to at least one of several characteristics, including: reduced crystal grain size, narrower size distribution due to crystal rotation, and further enhancement of magnetic decoupling due to crystal rotation.

These positive characteristics of the perpendicular magnetic recording layer 514 may be caused by the third interlayer 510, which leads to smaller magnetic crystal clusters in the recording layer 514, since it has good crystalline quality from the first interlayer 508 and seed layer 506, such that crystallinity and crystallographic texture of the layers above the third interlayer 510, such as the second interlayer 514, have better crystalline quality, as compared to conventional techniques of magnetic medium formation.

Above the perpendicular magnetic recording layer 514 is a protective overcoat layer 516, and above the protective overcoat layer 516, in some embodiments, a lubricating layer may be formed. Typically, the lubricating layer may be applied onsite as the magnetic disk drive having the PMRM therein is used. Although each layer is depicted having the same thickness in FIG. 5, the invention is not so limited. Each layer may have a different shape, thickness, length, depth, etc., and the design thereof may be determined by the affect desired.

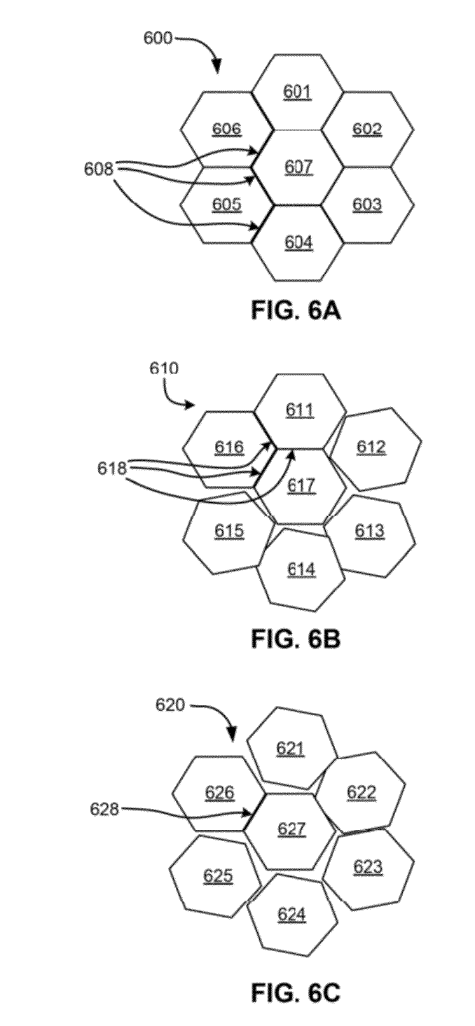

FIG. 6A illustrates a magnetic cluster 600, according to one embodiment. In FIG. 6A, seven adjacent crystal grains are shown. Of course, in use, more crystal gains are present in a magnetic medium. FIG. 6A is meant to illustrate the interaction of the crystal grains, and should not be construed as being limiting on the embodiments disclosed herein. Each crystal grain 601, 602, 603, 604, 605, 606, and 607 has substantially identical rotational phase, and each crystal grain 601, 602, 603, 604, 605, 606, and 607 forms a magnetic coupling 608 with all in-phase neighbors, creating a magnetic cluster 600 of seven grains. There may be magnetic clusters with more or less crystal grains, according to various embodiments. This pattern may be repeated across all or some of a magnetic medium, according to some embodiments.

FIG. 6B illustrates seven adjacent crystal grains, some of which form a magnetic cluster 610, according to one embodiment. Crystal grains 611, 616, and 617 have substantially identical rotational phase, while crystal grains 612, 613, 614 and 615 are out-of-phase with 611, 616, and 617 and with each other. Each in-phase crystal grain 611, 616, and 617 forms a magnetic coupling 618 with all in-phase neighbors, creating a magnetic cluster 610 of three grains. This pattern may be repeated across all or some of a magnetic medium, according to some embodiments.

FIG. 6C illustrates seven adjacent crystal grains, some of which form a magnetic cluster 620, according to one embodiment. Crystal grains 626 and 627 have substantially identical rotational phase, while crystal grains 621, 622, 623, 624 and 625 are out-of-phase with 626 and 627 and with each other. In-phase crystal grains 626 and 627 form a magnetic coupling 628, creating a magnetic cluster 620 of two grains. This pattern may be repeated across all or some of a magnetic medium, according to some embodiments.

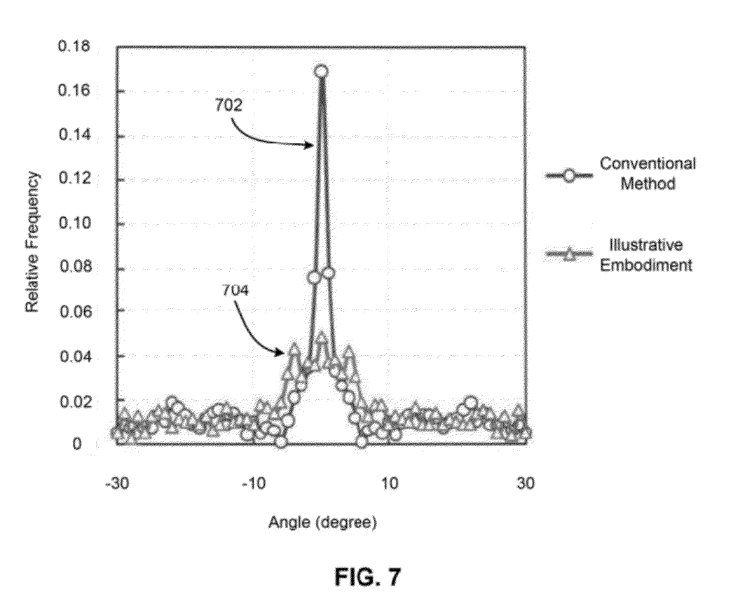

Now referring to FIG. 7, one effect of smaller cluster size of the third interlayer is shown by the crystal grain distribution of the second interlayer, according to one embodiment. As can be seen, line 702, which is the crystal angle difference of neighboring grains formed using conventional magnetic medium formation techniques, has a narrow distribution around 0 degree rotation, indicating that most of the crystal grains have the same or similar crystallography. In contrast, line 704, which is the crystal angle difference of neighboring grains formed using magnetic medium formation techniques disclosed herein, has a wide distribution around 0 degrees, indicating that the crystal grains have different crystallography due to crystal rotation.

### EXPERIMENTS

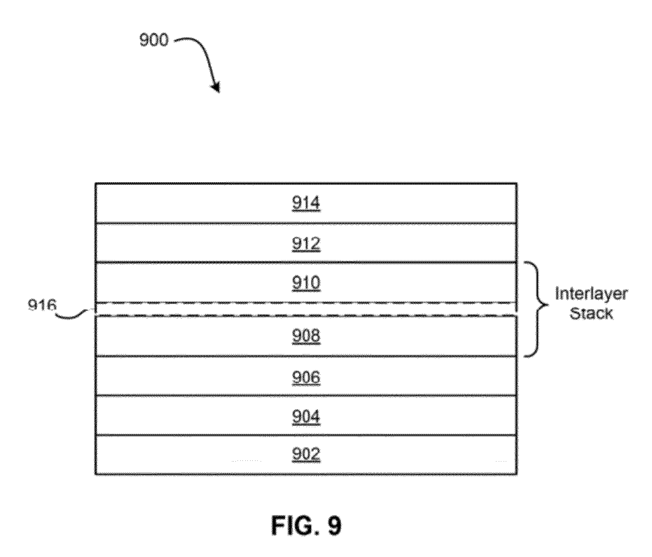

A PMRM 900 having a cross-sectional structure as shown in FIG. 9 was produced using a sputtering apparatus. A soft magnetic underlayer 904, a seed layer 906, a first interlayer 908, a second interlayer 910, a perpendicular magnetic recording layer 912, and a protective overcoat layer 914 were stacked in succession on a substrate 902 using DC magnetron sputtering, and a sample for evaluation was prepared (Comparative Example 1). A glass substrate of diameter 65 mm and thickness 0.635 mm was used for the substrate 902. The substrate 902 was not heated. The soft magnetic underlayer 904 had a composite structure in which, under conditions of Ar gas pressure 0.7 Pa, an Fe-34 at % Co-10 at % Ta-5at % Zr alloy film of thickness 15 nm was formed, a Ru film of thickness 0.6 nm was stacked thereon, and another Fe-34at % Co-10 at % Ta-5 at % Zr alloy film of thickness 15 nm was stacked thereon. The seed layer 906 was an Ni-8 at % Cr-6 at % W alloy film of thickness 7 nm which was formed under conditions of Ar gas pressure 0.7 Pa. The first interlayer 908 was a Ru film of thickness 8 nm which was formed under conditions of Ar gas pressure 1 Pa. The second interlayer 910 was a Ru film of thickness 8 nm which was formed under conditions of Ar gas pressure 5 Pa. The perpendicular magnetic recording layer 912 was a Co-21 at % Cr-18 at % Pt-5 mol % SiO₂-5 mol % TiO₂-1.5 mol % Co₃O₄ alloy film of thickness 13 nm which was formed under conditions of gas pressure of 5 Pa using a mixed gas comprising 1.5 vol % oxygen with Ar. The protective overcoat layer 914 was a carbon film of thickness 3.5 nm which was formed under conditions of 0.6 Pa using a mixed gas comprising 8 vol % nitrogen with Ar. This medium was used to evaluate microstructure and magnetic clusters, and the recording and reproduction characteristics were not evaluated, so no lubricant layer was provided.

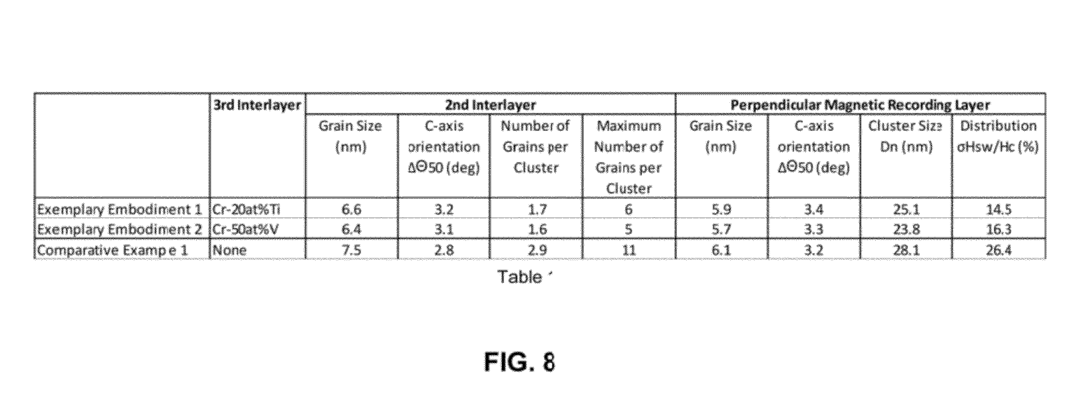

The difference between Exemplary Embodiments 1 and 2, and Comparative Example 1 as shown in Table 1 in FIG. 8 lies in the absence or presence of a third interlayer which is positioned between the first and second interlayers: the media in Exemplary Embodiments 1-2 have the third interlayer 916, while this interlayer is not present in Comparative Example 1.

The crystal grain size of the media of Exemplary Embodiments 1 and 2, and Comparative Example 1 were measured using a thin-film X-ray diffraction apparatus. This process involved measuring the in-plane diffraction spectra, and the spectra obtained were analyzed, and the crystal grain size was obtained using the Scherrer method. As shown in Table 1, in FIG. 8, it is clear that the grain size of the second Ru interlayer and the perpendicular magnetic recording layer in the media of Exemplary Embodiments 1 and 2 was finer than that of Comparative Example 1.

The actual cluster size and distribution were then measured by a process involving analysis of the minor loop, using a Kerr effect magnetic characteristics evaluation apparatus. The saturation magnetization value Ms measured by means of a vibrating sample magnetometer was used for calibrating the absolute value of magnetization. As shown by the results in Table 1, in FIG. 8, it is clear that the media of Exemplary Embodiments 1 and 2 had a finer cluster size than the medium of Comparative Example 1 by around 11% to 15%, and the distribution was narrower by at least 10 points. This was consistent with the results from analysis of TEM images.

As described above, a preferred structure of the third interlayer is a BCC structure, and therefore it preferably comprises Cr and/or V, or an alloy in which one of Cr and V are a primary component.

A medium having the same structure as that of Exemplary Embodiment 1 was produced in which the third interlayer was a Cr—Ti alloy film of thickness 2.5 nm which was formed under conditions of Ar gas pressure 0.9 Pa (Exemplary Embodiment 3). In this exemplary embodiment, two targets, a Cr target and a Ti target, were sputtered at the same time, and the alloy composition was changed by varying the sputtering proportions.

A medium having the same structure as that of Exemplary Embodiment 1 was produced in which the third interlayer was replaced with a Cr—V alloy film of thickness 2.5 nm which was formed under conditions of Ar gas pressure 0.9 Pa (Exemplary Embodiment 4). In this exemplary embodiment, two targets, a Cr target and a V target, were sputtered at the same time, and the alloy composition was changed by varying the sputtering proportions.

A preferred compositional range of the third interlayer comprising a CrTi alloy or a CrV alloy is described using the media of Exemplary Embodiments 3 and 4. According to the results of testing on Exemplary Embodiments 3 and 4, the effect of refining the crystal grain size is greater when the Ti content is 15 at %-80 at %, more preferably 40 at %-60 at %, with respect to Cr in the case of a CrTi alloy, and when the V content is 30 at %-70 at %, more preferably 40 at %-60 at %, with respect to Cr in the case of a CrV alloy. However, if the added concentration of Ti exceeds 30 at % in the case of a CrTi alloy, the crystallinity markedly deteriorates, and the crystallinity of the second Ru or Ru alloy interlayer above, and also of the perpendicular magnetic recording layer is lost, and this is clearly undesirable. In an overall context, these results indicate that the Ti content is preferably 15 at %-25 at % with respect to Cr in the case of a CrTi alloy, and the V content is preferably 30 at %-70 at %, more preferably 40 at %-60 at %, with respect to Cr in the case of a CrV alloy.

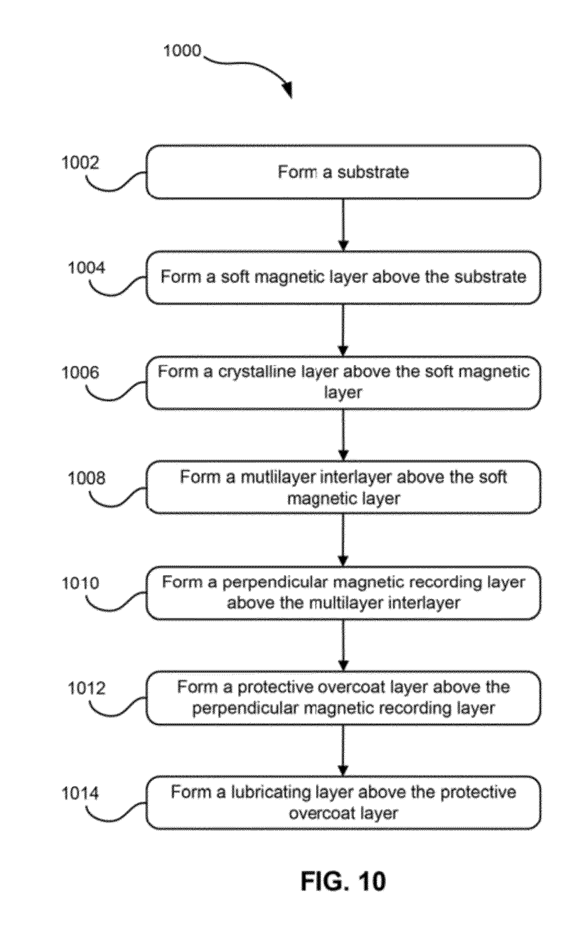

Referring now to FIG. 10, a method 1000 for forming a perpendicular magnetic recording medium is shown according to one embodiment. The method may be performed in any desired environment, and may include any of the embodiments and/or approaches described herein. The method 1000 may include more or less steps than those described below. For example, in one embodiment, the method 1000 may include operations 1008-1010 only, not operations 1002-1006 and 1012, etc.

For each of the operations described below, layers of a perpendicular magnetic recording medium are formed. Any formation method known in the art may be used to form these layers, such as sputtering, plating, electroplating, vapor deposition, plasma enhanced vapor deposition (PEVD), chemical vapor deposition (CVD), etc., and different formation methods may be used for all or some of the layers.

In operation 1002, a substrate is formed. The substrate may comprise glass, silicon, or any other material as known in the art.

In operation 1004, a soft magnetic layer is formed above the substrate and below a subsequent crystalline seed layer. The soft magnetic layer may be comprised of any material known in the art, such as FeCoTaZr, a FeCoTaZr alloy, Ru, a Ru alloy, combinations thereof, etc. In one approach, the soft magnetic layer may adhere the substrate to a crystalline seed layer formed subsequently in operation 1006.

In operation 1006, a crystalline seed layer is formed above the soft magnetic layer and below a subsequent multilayer interlayer. Any material may be used to form the seed layer as would be known to one of skill in the art, such as NiCrW, a NiCrW alloy, etc. The seed layer may have a thickness of about 2 nm to about 10 nm, such as about 7 nm. In one approach, the crystalline seed layer may have good crystallographic texture that provides adequate crystal grain size for subsequent layers, such as the multilayer interlayer and perpendicular magnetic recording layers formed in the next two operations.

In operation 1008, a multilayer interlayer is formed above the soft magnetic layer. In one embodiment, the multilayer interlayer includes three layers, a first interlayer formed above the substrate, a second interlayer formed above the first interlayer, and a third interlayer formed between the first interlayer and the second interlayer. Of course, any number of interlayers may be used, including four, five, six, etc., as would enhance the properties of the layers formed subsequent to the interlayer.

According to one embodiment, the first interlayer and second interlayer may comprise Ru or a Ru alloy. In another approach, the first interlayer and the second interlayer may each have a thickness of between about 6 nm and about 10 nm, such as about 8 nm.

In another approach, the third interlayer may have a body-centered-cubic (BCC) structure, or a structure closely related to BCC, such as B2, C11b, L21, and D03. Additionally, for BCC structures, the third interlayer may comprise at least one of Cr, Ti, and V, such as CrTi having a Cr concentration of about 20 at %, CrV having a Cr concentration of about 50 at %, or alloys thereof. For B2, C11b, L21, and D03 structures, the third interlayer may comprise an intermetallic compound, such as at least two of Al, Si, Ti, Cr, Mn, Fe, Co, Ni, Cu, Zr, Nb, Mo, Ru, Ta, and Re. According to one embodiment, the third interlayer may have a thickness of between about 0.5 nm and about 3.0 nm, such as about 2.0 nm.

In operation 1010, a perpendicular magnetic recording layer is formed above the multilayer interlayer. In one embodiment, the perpendicular magnetic recording layer may comprise CoCrPtSiO₂TiO₂Co₃O₄ or an alloy thereof, or any other material known in the art. In some approaches, the perpendicular magnetic recording layer may have a thickness of about 7 nm to about 20 nm, such as about 16 nm.

In operation 1012, a protective overcoat layer is formed above the perpendicular magnetic recording layer for protecting the perpendicular magnetic recording layer. The protective overcoat layer may comprise any material known in the art, such as alumina, carbon and carbon compounds, etc. In some embodiments, the protective overcoat layer may have a thickness of about 0.5 nm to about 2 nm, such as about 1 nm.

According to another embodiment, a system includes a perpendicular magnetic recording medium as described in any of the embodiments described above, at least one magnetic head for reading from and/or writing to the perpendicular magnetic recording medium, a magnetic head slider for supporting the magnetic head, and a control unit coupled to the magnetic head for controlling operation of the magnetic head. This embodiment may include any of the descriptions relating to FIGS. 1-4B.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A perpendicular magnetic recording medium, comprising:
a first interlayer comprising Ru or a Ru alloy;
a second interlayer above the first interlayer comprising Ru or a Ru alloy; and
a third interlayer formed between the first interlayer and the second interlayer that reduces an average cluster size of the second interlayer.

2. The perpendicular magnetic recording medium of claim 1, wherein the third interlayer has a body-centered-cubic (BCC) structure.

3. The perpendicular magnetic recording medium of claim 2, wherein the third interlayer comprises at least one of Cr and V.

4. The perpendicular magnetic recording medium of claim 3, wherein the third interlayer has a thickness of between about 1.0 nm and about 3.0 nm.

5. The perpendicular magnetic recording medium of claim 1, wherein the third interlayer has a structure selected from a group consisting of: B2, C11b, L21, and D03.

6. The perpendicular magnetic recording medium of claim 5, wherein the third interlayer comprises an intermetallic compound.

7. The perpendicular magnetic recording medium of claim 6, wherein the third interlayer comprises at least two of: Al, Si, Ti, Cr, Mn, Fe, Co, Ni, Cu, Zr, Nb, Mo, Ru, Ta, and Re.

8. The perpendicular magnetic recording medium of claim 7, wherein the third interlayer has a thickness of between about 1.0 nm and about 3.0 nm.

9. The perpendicular magnetic recording medium of claim 1, further comprising a crystalline seed layer below the first interlayer, wherein the crystalline seed layer has a good crystallographic texture for providing adequate crystal grain size in subsequent layers.

10. The perpendicular magnetic recording medium of claim 1, further comprising a perpendicular magnetic recording layer having a good crystallographic texture immediately above the second interlayer.

11. The perpendicular magnetic recording medium of claim 10, further comprising a protective overcoat layer above the perpendicular magnetic recording layer for protecting the perpendicular magnetic recording layer.

12. A system, comprising:
a perpendicular magnetic recording medium as described in claim 1;
at least one magnetic head for reading from and/or writing to the magnetic recording medium;
a magnetic head slider for supporting the magnetic head; and
a control unit coupled to the magnetic head for controlling operation of the magnetic head.

13. A perpendicular magnetic recording medium, comprising:
a first interlayer comprising Ru or a Ru alloy;
a second interlayer above the first interlayer comprising Ru or a Ru alloy; and
a third interlayer formed between the first interlayer and the second interlayer that reduces an average cluster size of the second interlayer,
wherein the third interlayer has a thickness of between about 1.0 nm and about 3.0 nm, and
wherein the third interlayer has a structure selected from a group consisting of: BCC, B2, C11b, L21, and D03.

14. A method for forming a perpendicular magnetic recording medium, the method comprising:
forming a multilayer interlayer, comprising:
forming a first interlayer above a substrate;
forming a second interlayer above the first interlayer; and
forming a third interlayer between the first interlayer and the second interlayer; and forming a perpendicular magnetic recording layer above the multilayer interlayer.

15. The method according to claim 14, wherein the perpendicular magnetic recording layer comprises CoCrPtSiO₂TiO₂Co₃O₄ or an alloy thereof.

16. The method according to claim 14, wherein the first interlayer and second interlayer comprise Ru or a Ru alloy.

17. The method according to claim 14, wherein the third interlayer has a body-centered-cubic (BCC) structure.

18. The method according to claim 17, wherein the third interlayer comprises at least one of Cr, Ti, and V and has a thickness of between about 1.0 nm and about 3.0 nm.

19. The method according to claim 18, wherein the third interlayer comprises CrTi having a Cr concentration of about 20 at %, CrV having a Cr concentration of about 50 at %, or alloys thereof.

20. The method according to claim 14, wherein the third interlayer has a structure selected from a group consisting of: B2, C11b, L21, and D03.

21. The method according to claim 20, wherein the third interlayer comprises an intermetallic compound.

22. The method according to claim 21, wherein the third interlayer comprises at least two of Al, Si, Ti, Cr, Mn, Fe, Co, Ni, Cu, Zr, Nb, Mo, Ru, Ta, and Re.

23. The method according to claim 22, wherein the third interlayer has a thickness of between about 1.0 nm and about 3.0 nm.

24. The method according to claim 14, further comprising first forming a crystalline seed layer below the multilayer interlayer, wherein the crystalline seed layer has good crystallographic texture that provides adequate crystal grain size for subsequent layers.

25. The method according to claim 24, further comprising first forming a soft magnetic layer above a substrate and below the crystalline seed layer, wherein the soft magnetic layer adheres the crystalline seed layer to the substrate.
